(19) United States
(12) Patent Application Publication
(10) Pub. No.: US 2020/0397640 A1
(43) Pub. Date: Dec. 24, 2020

(54) Arm Bar

(71) Applicant: Valerie Gibson, Fairfax, VA (US)

(72) Inventor: Valerie Gibson, Fairfax, VA (US)

(21) Appl. No.: 16/904,847

(22) Filed: Jun. 18, 2020

Related U.S. Application Data
(60) Provisional application No. 62/863,139, filed on Jun. 18, 2019.

(51) Int. Cl. A61H 1/02

(52) U.S. Cl. CPC A61H 1/0274; A61H 2201/165; A61H 2201/5061; A61H 2201/5007; A61H 2201/1659; A61H 2205/06; A61H 2201/1207

(57) ABSTRACT

The instant invention directs to a physical therapy device and a method for manufacturing the device, in particular, an arm bar. The arm bar includes 3D-printed components constructed utilizing PLA filament. This simplified the fabrication process, as well as allowed for the 3D models to be adjusted quickly and reprinted until the positioning on the arm was strong, reliable, and functional. The major advantages of 3D-printing components are that they are relatively inexpensive and can be rapidly prototyped.

### FIELD OF THE INVENTION

The invention relates to a physical therapy device.

### BACKGROUND OF THE INVENTION

Significant research has been conducted to establish the benefits of assisting arm and hand movements.

Robotic exoskeletons exist which support a patient's weight, and mimic a normal upper body extension cycle. While these devices exist, they are exceedingly expensive, require highly trained operators, and are not always able to fail in a safe manner without operator intervention.

Functional electrical stimulation (FES) is a well-known and well-regarded technique whereby small electrical pulses are applied to weak or paralyze muscles using electrodes temporarily adhered to the patient's skin, to stimulate movement. Benefits of functional electrical stimulation include improved physical integrity, increased muscle size and strength, reduced spasticity, and enhanced neurological performance. FES can be coupled with functional movement, including cycling and walking. Emerging research indicates that neural restoration is possible and a significant amount of literature exists demonstrating the role of activity-dependent neural plasticity. FES in patients with SCI provides a mechanism for optimizing the neural activity amount below injury level. Existing FES leg and arm cycles are costly, and as a result, are often unavailable to patients who would benefit by their use. FES has also been incorporated into other devices which replicate body motion, but again, these devices are very expensive and typically are only available at well-funded clinics.

### SUMMARY OF THE INVENTION

A robotic arm is provided to assist in physical therapy and rehabilitation. The arm can be used by patients who have suffered a form of paralysis in the arm or any movement-limiting condition which has prevented the patient form being able to move the arm naturally without assistance.

The robotic arm is mounted on the patient's arm and employs a combination of sensors, motors, and additional required elements, resulting in a system that supports the weight of the patient's limb, allows for full range of motion, and is capable of driving the limb through therapist-selected functional movement.

Additionally, it is manufactured utilizing 3D printing and designed to be modular for flexibility in assembly and use of the robotic arm for various purposes.

### DETAILED DESCRIPTION OF THE PREFERRED EMBODIMENT

In the initial design phases of the project, various alternatives were considered, primarily consisting of different types of sensors to be used as the primary detectors of intent of motion by the patient. The three initial designs relied on the use of either electromyography (EMG), force-resistive sensors, or flex sensors as the primary signal outputs by the user and input into the microcontroller. Additionally, different motion actuators were considered including springs, servo motors, and linear actuator. After evaluation of the various design concepts, the design utilizing EMG sensors and servo motors at the various joints was chosen due to the small, standardized form factor of servo motors, and the high sensitivity of EMG sensors.

The final design for the robotic arm is outlined by 3D models designed for comfort and functionality for the patient's arm, as well as embedded with gears at the servo motor locations for the best rigidity as well as torque delivery. Using a backpack-style mount, the robotic arm has been designed to be mounted using thin metal bars to distribute most of the load to the hips of the patient. Additionally, the Arduino controller has been programmed to read the signals form the EMG sensors attached to the appropriate muscle groups of the patient's arm, resulting in the activation of the servo motors to complete the motion for the patient as well as bring the arm back to its neutral resting position when no muscle intent is detected. The controller is reprogrammable for specific functionality using an Android tablet. Mechanical knobs and buttons are also connected with the Arduino controller in order to place limits on the range of motion for the specific joint as well as control the servo motors manually, as desired by the physical therapist.

The 3D-printed components were constructed utilizing PLA filament. This simplified the fabrication process, as well as allowed for the 3D models to be adjusted quickly and reprinted until the positioning on the arm was strong, reliable, and functional. The major advantages of 3D-printing components are that they are relatively inexpensive and can be rapidly prototyped. The components were assembled utilizing standard sized bolts, bearings, and Velcro straps. The entire assembly was bolted onto the backpack mount behind the shoulder for the arm using the robotic arm. Utilizing 3D-printed components and readily available hardware, the fabrication process is extremely efficient and new or replacement components are relatively quick to produce.

Analysis, Simulation, Modeling, and Testing Results

First, calculations were made in order to determine the size of the batteries and servo motors that would be required to operate the robotic arm. After the 3D models were designed, they were analyzed for mechanical stress using finite element analysis, which demonstrated that the PLA material could withstand the stresses induced by the torque from the servo motors and the weight of the arm. Once the arm was physically assembled for prototyping, the components were tested for any weakness or potential failure due to cracking under stresses, where the components and servo motors proved to be sufficiently strong and capable of moving the joints of the arm without failure.

Performance Results, and Benefits

The robotic arm has proven to provide assistance required for patients requiring mechanical assistance for natural arm motion. The project has therefore introduced a functional prototype that can be improved upon and used for research in the medical field. This project aims to increase the accessibility of this type of technology to patients requiring mechanical assistance for natural limb motion. The only currently available technology of similar purpose functions to assist the hand and elbow, while the ARMBAR team's device also incorporates the shoulder and at a fraction of the cost. It also includes additional customization options, has a more robust control system, and incorporates a modular system, which is a significant improvement over the currently available alternatives.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. An arm bar, including:
a microcontroller;
a plurality of force-resistive sensors;
a plurality of motion actuators; and
a plurality servo motors.
